(19) United States
(12) Patent Application Publication
(10) Pub. No.: US 2008/0260944 A1
(43) Pub. Date: Oct. 23, 2008

(54) Water-Activated Non Blocking Adhesive

(75) Inventors: William Ford Wilson, Hawthorne, NJ (US); Gary F. Dandreaux, Hackensack, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: SUN CHEMICAL CORPORATION, Parsippany, NJ (US)

(21) Appl. No.: 11/738,177

(22) Filed: Apr. 20, 2007

(51) Int. Cl. C08L 91/00; B05D 5/10

(52) U.S. Cl. 427/207.1; 524/315

(57) ABSTRACT

A water-activated adhesive composition is disclosed containing: a hydrophobic polyurethane resin; a polyvinylpyrrolidone compound; and a fatty acid ester, wherein a dry film of the composition forms an adhesive bond between two substrates when exposed to water and allowed to re-dry.

### FIELD OF THE INVENTION

The invention relates to an adhesive which is activated with water. The water activated adhesive is tacky and forms an adhesive bond between two substrates when allowed to dry.

### BACKGROUND OF THE INVENTION

U.S. Pat. No. 5,045,601 discloses an adhesive composition comprising a polymer adhesive that is soluble or dispersible in water and is low-temperature curable to form a solid which is single-phase at ambient temperature, pressure-sensitive, dermatologically acceptable, moisture vapor-permeable, and resistant to dissolution when exposed to water. The polymer adhesive is hydrophilic polyurethane which, after curing, swell without dissolving in water. In addition, this reference does not teach the use of polyvinylpyrrolidone in the adhesive composition.

U.S. Pat. No. 5,662,960 discloses the preparation of hydrogel coating compositions for use in medical devices. More specifically, it teaches covalently attached protective polyurethane-polyurea (PU/PUR) hydrogel coating and its combination with the structurally dissimilar second hydrogel polymer which is slippery when wet and the intimately commingled hydrogel substrate surface exhibits excellent permanence and wear characteristics when exposed to dynamic forces in the presence of various body fluids, especially blood.

U.S. Pat. No. 4,835,003 teaches coating medical tubing with a polyurethane and polyvinylpyrrolidone to form a lubricating coating. The coating may be applied to the medical tubing using a volatile solvent vehicle, in solution or as an emulsion with the volatile solvent. The two ingredients, a hydrophilic polyurethane resin and polyvinyl pyrrolidone, should be intimately mixed, so that as the volatile solvent dries, leaving behind the coating, the polyvinyl pyrrolidone forms a separate phase from the resin, intimately dispersed throughout the polyurethane coating. Accordingly, the polyvinyl pyrrolidone bleeds to the surface to provide a lubricating characteristic.

U.S. Pat. No. 4,119,094 teaches the preparation of coatings containing both polyurethane and polyvinylpyrrolidone having low coefficient of friction when wetted with a water based liquid. When coating a substrate, a polyisocyanate is applied along with a polyurethane in a solvent and then a polyvinylpyrollidone is subsequently applied in a solvent to form a polyvinylpyrollidonepolyurethane interpolymer.

U.S. Pat. No. 4,100,309 teaches the preparation of a coatings containing both polyurethane and polyvinylpyrrolidone having low coefficient of friction when wetted with a water based liquid.

U.S. Pat. No. 4,990,357 teaches the preparation of a lubricious coating composition by blending a hydrophilic polyurethane with a hydrophilic polymer such as polyvinylpyrrolidone. The lubricious coating composition comprises a substantially uniform blend of a hydrophilic polymer and an elastomeric segmented hydrophilic polyetherurethane which is the reaction product of a diisocyanate, a hydrophilic polyether glycol and a diol chain extender.

### SUMMARY OF THE INVENTION

The present invention provides a water-activated adhesive composition comprising:

(a) a hydrophobic polyurethane resin;

(b) a polyvinylpyrrolidone compound; and

(c) a fatty acid ester.

Preferably, a dry film of said composition forms an adhesive bond between two substrates when exposed to water and allowed to re-dry.

The present invention also provides a method of preparing a water-activated adhesive composition comprising mixing a hydrophobic polyurethane resin, a polyvinylpyrrolidone compound and a fatty acid ester in an organic solvent to form a solution.

Other objects and advantages of the present invention will become apparent from the following description and appended claims.

### DETAILED DESCRIPTION OF THE INVENTION

The present invention relates to an adhesive which is activated with water. The water activated adhesive is tacky and forms an adhesive bond between two substrates when allowed to dry. The dried adhesive film does not block under conditions of high temperature, humidity and pressure.

The adhesive solution of the present invention is prepared by mixing a polyurethane solution, polyvinylpyrrolidone and a fatty acid ester in an appropriate solvent. The solution is coated onto a substrate and dried to form the water-activated adhesive. The dried adhesive film does not block under high temperature, pressure, and humidity conditions.

### Polyurethane Resin

The polyurethane resin of the present invention is hydrophobic. The term “hydrophobic” is to be understood to mean water insoluble. It also means that it does not turn into gel in the presence of water. The polyurethane resin when used in the composition of the present invention acts as a binder that stops said composition from being tacky and from adhering to other surfaces when coated as a film. In addition, upon exposure to water, the polyurethane resin allows for better sticking properties for the composition of the present invention.

The polyurethane of the present invention can be obtained by reacting one or more aliphatic and/or aromatic diisocyanates with isocyanate-reactive components consisting of one or more diols, and, optionally, one or more diamines.

The mixture of aliphatic diisocyanates and aromatic diisocyanates is described such that, of the total molar charge of diisocyanate, the sum total of aliphatic diisocyanate component(s) is greater than 10% but less than 90%. Additionally, the sum total of aromatic diisocyanate component(s) is greater than 10% but less than 90% of the total molar charge of diisocyanate.

The term “aliphatic diisocyanate” is to be understood as to comprise straight-chain aliphatic, branched aliphatic as well as cycloaliphatic diisocyanates. Preferably, the diisocyanate comprises 1 to 10 carbon atoms. Examples of preferred diisocyanates are 1,4-diisocyanatobutane, 1,6-diisocyanatohexane, 1,5-diisocyanato-2,2-dimethylpentane, 4-trimethyl-1,6-diisocyanatohexane, 1,10-diisocyanatodecane, 1,3- and 1,4-diisocyanatocyclo-hexane, 1-isocyanato-5-isocyanatomethyl-3,3,5-trimethylcyclohexane (isophorone diisocyanate (IPDI)), 2,3-2,4- and 2,6-diisocyanato-1-methylcyclohexane, 4,4′- and 2,4′-diisocyanatodicyclohexylmethane, 1-isocyanato-3-(4)-isocyanatomethyl-1-methyl-cyclohexane, 4,4′- and 2,4′-diisocyanatodiphenylmethane, and mixtures thereof, or 2,2,4- or 2,4,4 trimethyldiisocyanatohexane (TMDI).

The term “aromatic diisocyanate” is to be understood as to compromise straight-chain aromatic, branched aromatic as well as cycloaromatic diisocyanates. Preferably, the diisocyanate comprises 1 to 10 carbon atoms. Examples of preferred diisocyanates are 1,1′-methylenebis[4-isocyanato-benzene (MDI), 1,3-diisocyanatomethyl-benzene (TDI), and 1,6-diisocyanato-hexane (HDI).

The diol components of the polyurethane resin of present invention include polyethyleneether glycols (PEG), polypropyleneether glycols (PPG) and polytetramethylene ether glycols (Poly-THF), 1,4-butanediol, 1,6-hexanediol, neopentyl glycol, or a mixture thereof. According to the present invention, the use of PPG is particularly preferred.

Optionally, as a further isocyanate-reactive component at least one diamine can be added. The diamine can be any aliphatic, cycloaliphatic, aromatic, or heterocyclic diamine having primary or secondary amino groups. Example are ethylenediamine, 1,2-diaminopropane, 1,3-diaminopropane, diaminobutane, hexamethylenediamine, 1,4-diaminocyclohexane, 3-aminomethyl-3,5,5-trimethylcyclohexylamine (isophorone diamine), m-xylylene diamine or 1,3-bis(aminomethyl) cyclohexane.

### Polyvinylpyrrolidone

Polyvinylpyrrolidone is the substance that provides the adhesive properties to the composition of the present invention upon exposure to water. Polyvinylpyrrolidone is available in a wide range of molecular weights, ranging from less than 10,000 to over 3 million as shown in Table 1. Polyvinylpyrrolidone with a molecular weight of less than 100,000 is particularly preferred.

TABLE 1
list of polyvinylpyrrolidone compounds with their
molecular weights

| | Molecular |
|---|---|
| | Weight |
| Grade | (GPC/MALLS) |
| K-15 | 9,700 |
| K-30 | 66,800 |
| K-60 | 396,000 |
| K-85 | 825,000 |
| K-90 | 1,570,000 |
| K-120 | 3,470,000 |

### Fatty Acid Ester Compounds

The fatty acid esters of the invention act to keep the composition of the present invention soft. They comprise any esters derived from C-8 to C-30 fatty acids, and can be linear, branched, saturated, or unsaturated. The methyl ester of linoleic acid is especially preferred.

### Solvent

The solvent allows for the hydrophobic polyurethane and the polyvinylpyrrolidone and the fatty acid ester of the present invention to be put in solution together. Preferably, the solvent is an organic solvent. More preferably, the solvent is isopropanol.

### EXAMPLE 1

The following materials were mixed together to form a solution: polyurethane solution (30.4 g), isopropanol (61.2 g), PVP K-30 (7.2 g; polyvinylpyrrolidone; International Specialty Products), PVP K-15 (2 g; polyvinylpyrrolidone; International Specialty Products) and Radia 7062 (1.2 g methyl linoleate, Oleon). The solution was coated onto a polypropylene (PP) film with a 95 Q flexo handproofer and dried at 80° C. for one minute. The dried film was sprayed with water using an atomizer and then applied to a poly(ethylene terephthalate) (PET) film. After overnight drying at room temperature there was adhesion of the PP to the PET. A second dried film was placed over an uncoated PP film to form a PP/dried adhesive/PP sandwich. The sandwich was placed in a block tester at 50 psi and the tester was placed in a chamber at 50° C. and 66% relative humidity overnight. No blocking was observed.

### EXAMPLE 2

A solution was prepared as in Example 1 except no methyl linoleate was included. Specifically, the following materials were mixed together to form a solution: polyurethane solution (30.4), isopropanol (74.4 g), PVP K-30 (7.2 g polyvinylpyrrolidone; International Specialty Products) and PVP K-15 (2 g; polyvinylpyrrolidone; International Specialty Products. The solution was coated onto a polypropylene (PP) film with a 95 Q flexo handproofer and dried at 80° C. for one minute. The dried film was sprayed with water using an atomizer and then applied to a poly(ethylene terephthalate) (PET) film. After overnight drying at room temperature there was adhesion of the PP to the PET. A second dried film was placed over an uncoated PP film to form a PP/dried adhesive/PP sandwich. The sandwich was placed in a block tester at 50 psi and the tester was placed in a chamber at 50° C. and 66% relative humidity overnight. No blocking was observed, but there was a slight cling when compared to Example 1.

### EXAMPLE 3

A solution was prepared as in Example 1 except no polyvinylpyrrolidone was included. Specifically, the following materials were mixed together to form a solution: polyurethane solution (52.6 g), isopropanol (51.0 g) and 1.2 g Radia 7062 (1.2 g methyl linoleate, Oleon). The solution was coated onto a polypropylene (PP) film with a 95 Q flexo handproofer and dried at 80° C. for one minute. The dried film was sprayed with water using an atomizer and then applied to a poly(ethylene terephthalate) (PET) film. After overnight drying at room temperature there was no adhesion of the PP to the PET. A second dried film was placed over an uncoated PP film to form a PP/dried adhesive/PP sandwich. The sandwich was placed in a block tester at 50 psi and the tester was placed in a chamber at 50° C. and 66% relative humidity overnight. No blocking was observed.

### EXAMPLE 4

A solution was prepared as in Example 1 except no polyurethane was used. Specifically, the following materials were mixed together to form a solution: isopropanol (86 g), PVP K-30 (13.7 g polyvinylpyrrolidone; International Specialty Products), PVP K-15 (3.8 g polyvinylpyrrolidone; International Specialty Products) and Radia 7062 (1.2 g methyl linoleate, Oleon). The solution was coated onto a polypropylene (PP) film with a 95 Q flexo handproofer and dried at 80° C. for one minute. The dried film was sprayed with water using an atomizer and then applied to a poly(ethylene terephthalate)(PET) film. After overnight drying at room temperature there was adhesion of the PP to the PET. A second dried film was placed over an uncoated PP film to form a PP/dried adhesive/PP sandwich. The sandwich was placed in a block tester at 50 psi and the tester was placed in a chamber at 50° C. and 66% relative humidity overnight. Some blocking had occurred.

### EXAMPLE 5

A solution was prepared as in Example 1 except no polyvinylpyrrolidone and methyl linoleate were used. Specifically, the following materials were mixed together to form a solution: 51 g isopropanol and 52.6 g polyurethane solution 3323-70. The solution was coated onto a polypropylene (PP) film with a 95 Q flexo handproofer and dried at 80° C. for one minute. The dried film was sprayed with water using an atomizer and then applied to a poly(ethylene terephthalate)(PET) film. After overnight drying at room temperature there was no adhesion of the PP to the PET. A second dried film was placed over an uncoated PP film to form a PP/dried adhesive/PP sandwich. The sandwich was placed in a block tester at 50 psi and the tester was placed in a chamber at 50° C. and 66% relative humidity overnight. No blocking was observed.

The invention has been described in terms of preferred embodiments thereof, but is more broadly applicable as will be understood by those skilled in the art. The scope of the invention is only limited by the following claims.

What is claimed is:

1. A water-activated adhesive composition comprising:
(a) a hydrophobic polyurethane resin;
(b) a polyvinylpyrrolidone compound; and
(c) a fatty acid ester.

2. The composition of claim 1, wherein a dry film of said composition forms an adhesive bond between two substrates when exposed to water and allowed to re-dry.

3. The composition of claim 1, wherein said polyurethane resin is obtained by reacting one or more aliphatic and/or aromatic diisocyanates with isocyanate-reactive components consisting of one or more diols, and, optionally, one or more diamines.

4. The composition of claim 1, wherein said polyvinylpyrrolidone compound has a molecular weight from about 5,000 to about 3.5 million daltons.

5. The composition of claim 4, wherein said polyvinylpyrrolidone compound has a molecular weight of less than 100,000 daltons.

6. The composition of claim 1, wherein said fatty acid ester comprise an ester derived from C-8 to C-30 fatty acids.

7. The composition of claim 1, wherein said fatty acid ester is selected from the group consisting of linear, branched, saturated, and unsaturated fatty acid ester.

8. The composition of claim 1, wherein said fatty acid ester is the methyl ester of linoleic acid.

9. A substrate having a surface coated by the composition of claim 1.

10. A substrate coated by the composition of claim 1 and then exposed to water to form an adhesive bond.

11. A method of preparing a water-activated adhesive composition comprising mixing a hydrophobic polyurethane resin, a polyvinylpyrrolidone compound and a fatty acid ester in an organic solvent to form a solution.

12. The method of claim 11, wherein said solution is coated onto a substrate and dried to form the water-activated adhesive.

13. The method of claim 11, wherein said polyurethane resin is obtained by reacting one or more aliphatic and/or aromatic diisocyanates with isocyanate-reactive components consisting of one or more diols, and, optionally, one or more diamines.

14. The method of claim 11, wherein said polyvinylpyrrolidone compound has a molecular weight from about 5,000 to about 3.5 million daltons.

15. The method of claim 14, wherein said polyvinylpyrrolidone compound has a molecular weight of less than 100,000 daltons.

16. The method of claim 11, wherein said fatty acid ester comprise an ester derived from C-8 to C-30 fatty acids.

17. The method of claim 11, wherein said fatty acid ester is selected from the group consisting of linear, branched, saturated, and unsaturated fatty acid ester.

18. The method of claim 11, wherein said fatty acid ester is the methyl ester of linoleic acid.

19. A substrate having a surface coated by a water-activated adhesive composition prepared according to claim 1.
